(19) United States
(12) Patent Application Publication
(10) Pub. No.: US 2026/0346285 A1
(43) Pub. Date: Nov. 5, 2026

(54) TABLETOP DISPENSERS WITH PUMP SPRINGS THAT ARE UNCOMPRESSED IN A STOWED POSITION

(71) Applicant: GOJO Industries, Inc., Akron, OH (US)

(72) Inventors: Nick E. Ciavarella, Seven Hills, OH (US); Daniel R. Simpson

(21) Appl. No.: 19/118,879

(22) PCT Filed: Oct. 4, 2023
(86) PCT No.: PCT/US2023/075909

§ 371 Date: Apr. 7, 2025

Related U.S. Application Data
(60) Provisional application No. 63/414,659, filed on Oct. 10, 2022.

(51) Int. Cl. B05B 11/10

(52) U.S. Cl. CPC B05B 11/106; B05B 11/1001; B05B 11/1047; B05B 11/1067; B05B 11/1074; B05B 11/1077

(57) ABSTRACT

Implementations of a tabletop dispenser are disclosed herein. A dispenser includes a container that has a neck, a pump, and a closure for securing the pump to the container. The pump includes a housing, a pump spring, a collet attached to an upper end of the pump housing, and a pump head that extends through the collet. The pump head is movable between a stowed and a deployed position. The pump spring is in an uncompressed condition when the pump head is in the stowed position.

### TECHNICAL FIELD

The present invention relates generally to tabletop dispensers and more particularly to tabletop dispensers having a pump spring that remains uncompressed when a pump head is in a stowed position.

### BACKGROUND OF THE INVENTION

Dispensers, such as, for example, soap and sanitizer dispensers, often include a pump head that can be pressed downward to actuate a piston of the pump and dispense the contents of the dispenser. A pump spring provides a return force to push the pump head and piston back into a charged position after the contents of the pump are discharged. When the dispenser is being stored or shipped, the pump head can be secured in stowed position to prohibit accidental discharge of the pump and to reduce the overall size of the dispenser. The pump spring is typically compressed when the pump head is secured in the stowed position.

Prior art pump springs are typically made of steel because pump springs made from some materials, such as, for example, plastic may lose some or all of their spring force, or the spring force may be reduced, if the spring is retained in a compressed condition for an expanded period of time.

It is difficult to recycle pumps made with steel springs because the steel spring needs to be separated from the plastic pump components prior to recycling. Thus, there is a need for a tabletop dispenser with a pump spring that can remain uncompressed when the pump head is in a stowed position.

### SUMMARY

Examples of tabletop dispensers having plastic springs that are stored in an uncompressed condition are disclosed herein. A dispenser includes a container that has a neck, a pump, and a closure for securing the pump to the container. The pump includes a housing, a pump spring, a collet attached to an upper end of the pump housing, and a pump head that extends through the collet. The pump head is movable between a stowed and a deployed position. The pump spring is in an uncompressed condition when the pump head is in the stowed position.

### BRIEF DESCRIPTION OF THE DRAWINGS

To further clarify various aspects of the present disclosure, a more particular description of inventive concepts will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale. Features and advantages of the present disclosure will be described and explained with additional specificity and detail through the use of the accompanying drawings in which:

FIG. 1 is a perspective view of an example of a tabletop dispenser with a pump in a stowed condition;

FIG. 2 is an exploded view of a pump of the example of the tabletop dispenser of FIG. 1;

FIG. 3 is a perspective cross-sectional view of the example of a tabletop dispenser of FIG. 1;

FIG. 4 is a partial cross-sectional view of the example of a tabletop dispenser of FIG. 1 with the pump in a stowed condition;

FIG. 5 is a perspective view of the example of a tabletop dispenser of FIG. 1 with the pump in a deployed condition;

FIG. 6 is a partial cross-sectional view of the example of a tabletop dispenser of FIG. 5;

FIG. 7 is a perspective view of an example of a tabletop dispenser with a pump in a stowed condition;

FIG. 8 is an exploded view of a pump of the example of a tabletop dispenser of FIG. 7;

FIG. 9 is a perspective cross-sectional view of the example of a tabletop dispenser of FIG. 7;

FIG. 10 is a top view of the example of a tabletop dispenser of FIG. 7 with the pump in a locked condition;

FIG. 11 is a top view of the example of a tabletop dispenser of FIG. 7 with the pump in an unlocked condition;

FIG. 12 is a partial cross-sectional view of the example of a tabletop dispenser of FIG. 10;

FIG. 13 is a partial cross-sectional view of the example of a tabletop dispenser of FIG. 11;

FIG. 14 is a perspective view of the example of a tabletop dispenser with the pump in a deployed condition; and

FIG. 15 is a partial cross-sectional view of the example of a tabletop dispenser of FIG. 12.

### DETAILED DESCRIPTION

The following description refers to the accompanying drawings, which illustrate specific aspects of the present disclosure.

As described herein, when one or more components are described as being connected, joined, affixed, coupled, attached, or otherwise interconnected, such interconnection may be direct as between the components or may be indirect such as through the use of one or more intermediary components.

Also as described herein, reference to a “member,” “component,” or “portion” shall not be limited to a single structural member, component, or element but can include an assembly of components, members, or elements. Also as described herein, the terms “substantially” and “about” are defined as at least close to (and includes) a given value or state (preferably within 10% of, more preferably within 1% of, and most preferably within 0.1% of).

In addition, although the description may be directed to sanitizer dispensers, the inventive concepts disclosed herein may be applied to soap dispensers, lotion dispensers and the like.

The pump springs disclosed herein are devoid of metallic parts. Preferably, the pumps are devoid of metallic parts. Accordingly, the entire pump may be recycled without the need for disassembling the pumps.

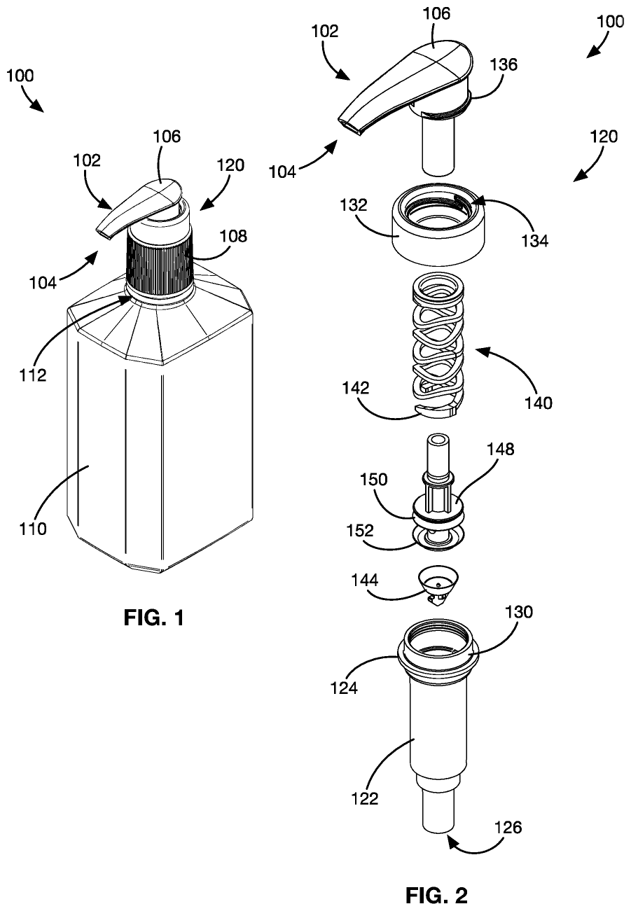

Referring now to FIGS. 1-6, illustrations of an exemplary dispenser 100 are shown. The dispenser 100 includes a nozzle 102 having a nozzle outlet 104.

The nozzle 102 extends upward from a pump 120, forming a pump head 106. A fluid, such as, for example, hand sanitizer, is dispensed from the nozzle 102 when the pump head 106 is depressed by a user. The fluid is supplied to the nozzle 102 from a bottle 110 via a pump 120. The pump 120 is attached to the bottle 110 via a closure 108. The closure 108 attaches to a neck 112 of the bottle 110 after the bottle 110 is filled with hand sanitizer. The connection between the closure 108 and the neck 112 can take on a wide variety of forms, such as, for example, a threaded connection, a quarter-turn connection, a snap connection, a barbed connection, a press fit connection, an adhesive connection, a welded connection, or any other suitable repeatable or permanent connection.

The neck 112 of the bottle 110 has a smaller diameter than the rest of the bottle 110 and includes a mouth or opening 114 that facilitates filling the bottle 110 with fluid, such as, for example, hand sanitizer. The bottle 110 encloses a reservoir 116 for holding the fluid, e.g. hand sanitizer, and has a bottom 118. The bottom 118 of the bottle 110 is shaped to provide improved stability when the bottle 110 is placed on a tabletop or other approximately horizontal surface. For example, in some instances, stability can be increased via an indentation or concavity in the center of the bottom so that the surface area of the bottle that is in contact with the tabletop is arranged towards the outer perimeter of the bottle 110.

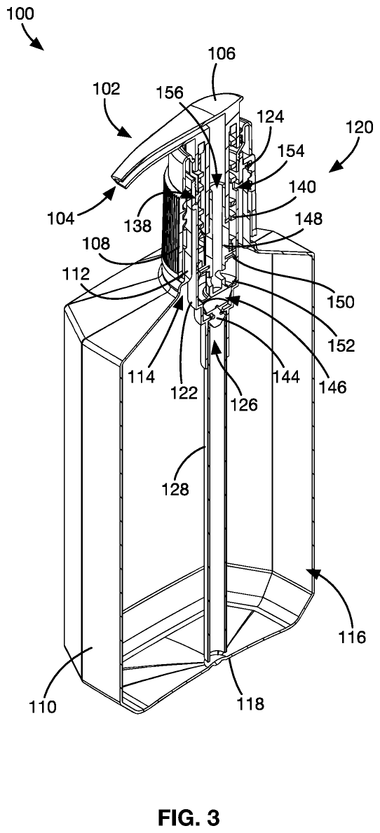

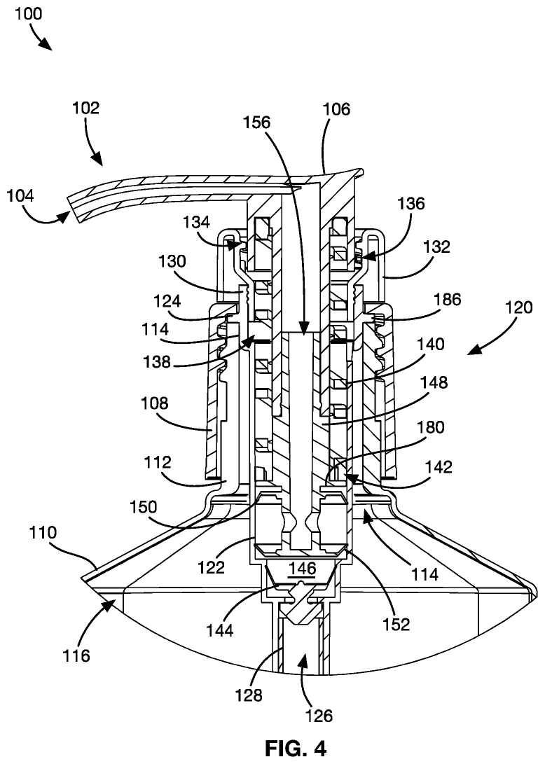

Referring now to FIGS. 3 and 4, cross-section views of the dispenser 100 and the pump 120 attached to the bottle 110 are shown. A pump housing 122, which has a cylindrical shape in this exemplary embodiment, encloses the pump 120. The pump housing 122 includes a flange 124 that engages the neck 112 of the bottle 110 when the pump 120 is inserted into the mouth or opening 114 of the bottle 110. The closure 108 secures the flange 124 against the neck 112 of the bottle 110 to form a seal between the pump 120 and the bottle 110 to prohibit leakage of hand sanitizer from the reservoir 116. An optional gasket or seal can be inserted between the mouth 114 of the bottle 110 and the flange 124 of the pump 120 to prohibit leakage from the reservoir 116.

The pump housing 122 extends into the bottle 110 to a pump inlet 126. An inlet tube 128 extends from the pump inlet 126 to near the bottom of the reservoir 116. Providing an inlet tube 128 that extends to the bottom of the reservoir 116 allows the dispenser 100 to dispense fluid from the reservoir 116 until the reservoir 116 is almost or completely empty, lengthening the time that the dispenser 100 can be used before it runs out and is disposed of or is refilled. Any suitable pump can be used to move fluid from the reservoir 116 to the nozzle outlet 104, such as, for example, a dome pump, a piston pump, a rotary pump, a gear pump, a liquid pump, a foam pump, or the like.

The pump housing 122 includes a cylindrical projection 130 that receives a collet or housing cap 132. The piston 122 extends upward through the pump housing cap or collet 132 attached to the upper end 130 of the pump housing 122.

The pump housing cap or collet 132 includes a retaining portion 134 for engaging a corresponding engagement portion 136 for retaining the pump head 106 in a compressed or stowed condition during shipment or storage of the dispenser 100 to prohibit unintentional actuation of the pump 120. The retaining portion 134 and the engagement portion 136 can take on a wide variety of forms, such as, for example, a threaded connection, a quarter-turn connection, a snap connection, or the like.

The cap or collet 132 extends into the pump housing 122 to form an annular recess 138 between the housing cap or collet 132 and the pump housing 122. The housing cap or collet 132 can be threaded into a threaded opening of the pump housing 122 as shown or can be attached in any other suitable way, such as, for example, via a quarter-turn connection, a snap connection, a barbed connection, a press fit connection, an adhesive connection, a welded connection, or any other suitable repeatable or permanent connection. The collet 132 and flange 124 secure closure 108 to the pump housing 122.

A pump spring 140 extends between the pump housing 122 and the pump head 106. The pump spring 140 biases the pump head 106 in an outward or upward direction to return the pump head 106 to the charged or primed position after actuation of the pump 120, as described below.

The pump spring 140 includes an expandable lower end 142 for engaging the annular recess 138. Expandable lower end 142 is biased outward. As can be seen in FIGS. 1 and 3-4, when the pump head 106 is in the stowed position (as originally stowed or shipped), the pump spring 140 is at least partially stored inside of the housing 122 and the expandable lower end 142 is compressed to fit within the pump housing 122.

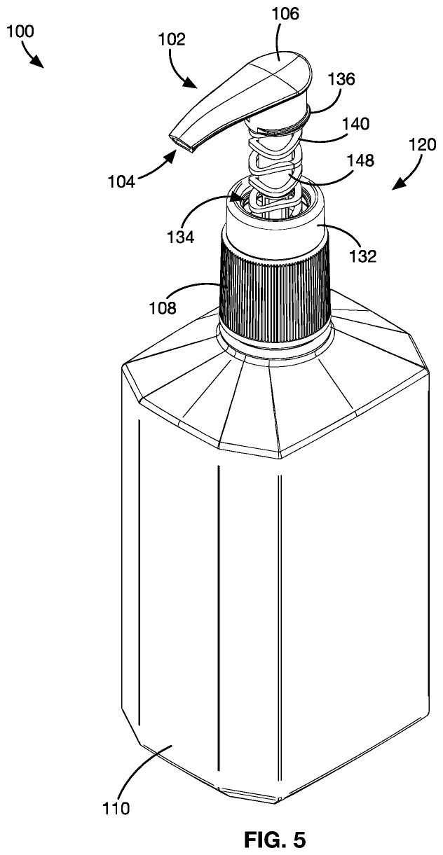

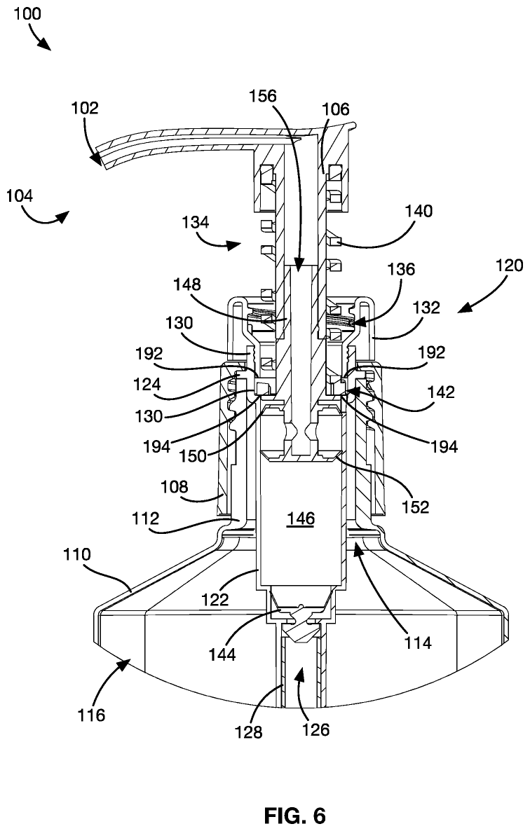

The pump head 106 can be pulled from the stowed position to the deployed position shown in FIGS. 5 and 6 by disengaging the retaining portions 134 of the pump head 106 from the engagement portion 136 of the collet 132 and then pulling outward or upward. Piston 148 includes an annular projection or flange 180. When the pump head 160, which is connected to the piston 148 is pulled upward, the annular projection or flange 190 moves the expandable lower end 142 upward (or outward). When the pump head 106 reaches the deployed position, the expandable lower end 142 is located proximate annular recess 138 and the expandable lower end 142 expands to fit within the annular recess 138 and is prohibited from further outward movement by the collet bottom surface 192. In addition, the expandable lower end 142 is prevented from moving back downward by seat 194 in in pump housing 122.

Once the expandable lower end 142 expands into recess 138, the expandable lower end 142 is retained therein and during subsequent downward or inward movement of pump head 106, the expandable lower end 142 remains within recess 138.

As shown, spring 140 has an anchor means, which is the expandable lower end 142 as shown, and a retention means 138.

Additional anchor means include one or more of a flange, a conical member, one or more outward extending ridges. Additional anchor means may include one or more of a rough textured surface on both parts, or a tapered surface on both sides to provide a cork like fit between parts. In some instances, the taper is configured so that the more the spring is pulled on/lifted, the more it wants to bind with the inner surface of the top of part 120.

Additional retention means 138 include one or more of a flange, one or more ridges, a recesses, one or more inwardly extending ridges. Additional anchor means may include one or more of a rough textured surface on both parts, or a tapered surface on both sides to provide a cork like fit between parts. In some instances, the taper is configured so that the more the spring is pulled on/lifted, the more it wants to bind with the inner surface of the top of part 120.

In some embodiments, the anchor means is on the spring 140 and in some embodiments, the anchor means is on the pump housing 122. In some embodiments, the retention means is on the spring 140 and in some embodiments, the retention means is on the pump housing 122.

The anchor means and the retention means are configured such that when the anchor means and the retention means engage, the end of the spring 140 is retained in its operating position. When the dispenser 100 is in its stowed position, the anchor means and the retaining means are not engaged and the end of the spring 140 may be moved upward or outward from the pump 120.

The lower end 142 of spring 140 has a first position with respect to the pump housing 122 when the pump head 106 is in a stowed position for shipping and/or storage and a second position with respect to the pump housing 122 when in the operational position. When the lower end 142 of the spring 140 moves from the first position to the second position, the lower end 142 of the spring is fixed with respect to the second position.

As can be seen in FIG. 2, the pump spring 140 can be a wave-style spring that includes wave-shaped undulations of a spiral of material such that the peak of one wave in the material aligns with the trough of a wave in the next layer of material. When the spring is compressed, the peaks and troughs of the adjacent waves engage each other and are flattened. Resistance to the flattening of these adjacent wave shapes is combined to provide the spring force of the pump spring 140 that biases the pump head 106 in an upward or expansion direction.

The pump spring 140 can be formed by injection molded plastic, or any other suitable material. Pump spring 140 may also be made by casting or by extruding a tube, die cutting plastic from the tube to reveal the spring and then heat bending the end(s) to create a portion that will lock in. In some instances, the spring 140 may be 3-D printed. Forming the pump spring 140 from plastic reduces the cost of manufacturing the dispenser 100 and facilitates the creation of portions of the pump spring 140, such as, for example, the expandable lower end 142. In addition, forming the pump spring 140 out of plastic allows the entire pump to be recycled without disassembling the pump and removing the spring.

Pump springs 140 formed from plastic materials can provide less spring force when the pump spring 140 has been held in a compressed condition for a period of time, such as during storage and shipment of the dispenser 100. That is, storage in a compressed condition can cause a plastic spring to lose elasticity, resulting in a changed spring constant and reduced spring force. The dispenser 100 allows the pump spring 140 to remain in an expanded condition inside of the pump housing 120 when the pump head 106 is in the stowed position prior to the dispenser 100 being placed in use. Consequently, the dispenser 100 can include a pump spring 140 formed from a plastic material and can also be put into a stowed condition that has a reduced vertical height—and thus a reduced volume—for storage and shipping. In this way, the dispensers 100 described herein enable reduced manufacturing, shipping, and storage costs as well as reducing costs associated with recycling the pump components.

A one-way inlet valve 144 is fluidly connected to the pump inlet 126 and a pump chamber or accumulator 146. The inlet valve 144 is a one-way valve that is oriented such that it allows fluid flow into the pump chamber 146 from the reservoir 116 when the chamber 146 expands due to upward movement of the piston 148. The inlet valve 144 can be any kind of one-way valve, such as a cross-cut valve, a ball and spring valve, a wiper valve, a poppet valve, a flapper valve, an umbrella valve, a slit valve, a mushroom valve, a duck bill valve, or the like.

The pump chamber 146 is enclosed by the pump housing 122, the inlet valve 144, and a piston 148. The piston 148 is hollow and includes a piston seal 150 and a pump outlet valve 152. The piston seal 150 forms a seal between the piston 148 and the pump housing 122. A container vent hole 154 is located in the pump housing 122 to provide an air path from the atmosphere into the reservoir 116 to equalize pressure in the container 110 when fluid is pumped out of the container. The pump outlet valve 152 is in fluid communication with the pump chamber 146 and a pump outlet 156. The pump outlet 156 is connected to the pump head 106 and nozzle 102 to provide a fluid path from the pump chamber 146 to the nozzle outlet 104 and to secure piston 148 to pump head 156.

The pump outlet valve 152 is a one-way valve that is fluidly connected to the pump chamber 146 and the pump outlet 156. The one-way outlet valve 152, like the pump inlet valve 144, is a one-way valve that is oriented such that it allows fluid flow out of the pump chamber 146 and into the pump outlet 156 when the pump chamber 146 is compressed. The outlet valve 152 can be any kind of one-way valve, such as a cross-cut valve, a ball and spring valve, a wiper valve, a poppet valve, a flapper valve, an umbrella valve, a slit valve, a mushroom valve, a duck bill valve, or the like.

The pump may be assembled by inserting the outlet valve 144 in the pump housing 122 and connecting dip tube 128 to the pump housing 122. The piston 148 is inserted into the pump housing 122. When the pump 120 is originally assembled, the spring 140 is inserted into the pump housing 122. The expandable lower end 142 of the spring 140 is compressed so that it fits into the lower part of pump housing 122. The expandable lower end 142 is pushed down into the housing 122 until the expandable lower end 142 contacts the annular projection or flange 180. The closure 108 is placed over the pump housing 122 and an upper flange 186 of the closure 108 contacts flange 124 of the pump housing. Collet 132 is secured to pump housing 122 and secures the closure 108 to the pump housing. Pump head 106 is secured to piston 148. Pump head 106 is pushed downward and secured to the collet 132 in a stowed position by engaging the retaining portion 134 of the pump head 106 to the corresponding engagement portion 136 of the collet 132. FIG. 4 illustrates the pump head 106 in its stored position with the uncompressed spring 140 located within the pump housing.

Once the container 110 is filled, the pump 120 is inserted in the neck 114 and secured to the neck 112 of container 110 by the closure 108. The pump head 106 remains in its stowed position and may be shipped to a consumer.

Initial activation of the dispenser 100 includes disengaging the retaining portion of the pump head 106 from the corresponding engagement portion of the collet 132 and pulling the pump head 106 and attached piston 148 upward. Annular projection or flange 180 moves the spring 140 and expandable lower end 142 upward until the expandable lower end 142 expands into recess 138, where it is retained by lower surface 192 of the collet and seat 194 of the housing. Expandable lower end 142 remains secured in recess 138 during normal operation of the dispenser 100.

FIG. 6 illustrates the dispenser 100 with the pump head 106 in a deployed position with the expandable lower end 142 secured in the recess 138, where it remains throughout use of the dispenser. During operation, the user presses down on the pump head 106 to move the piston 148 downward to compress the pump chamber 146 and pump spring 140. During compression of the pump chamber 146, the fluid pressure in the pump chamber increases so that the inlet valve 144 closes or seals and the outlet valve 152 opens, thereby allowing the contents of the pump chamber 146 to flow out of the outlet valve 152, through the nozzle 102 and nozzle outlet 104, and into the hand of the user. When force on the pump head 106 is released, the pump spring 140 pushes the piston 148 upward to expand the pump chamber 146. During expansion of the pump chamber 146, the pressure in the pump chamber 146 reduces, the inlet valve 144 opens and the outlet valve 152 closes, thereby filling the pump chamber 146 with fluid from the reservoir 116 to charge the pump 120 for the next time a user wants to dispense hand sanitizer.

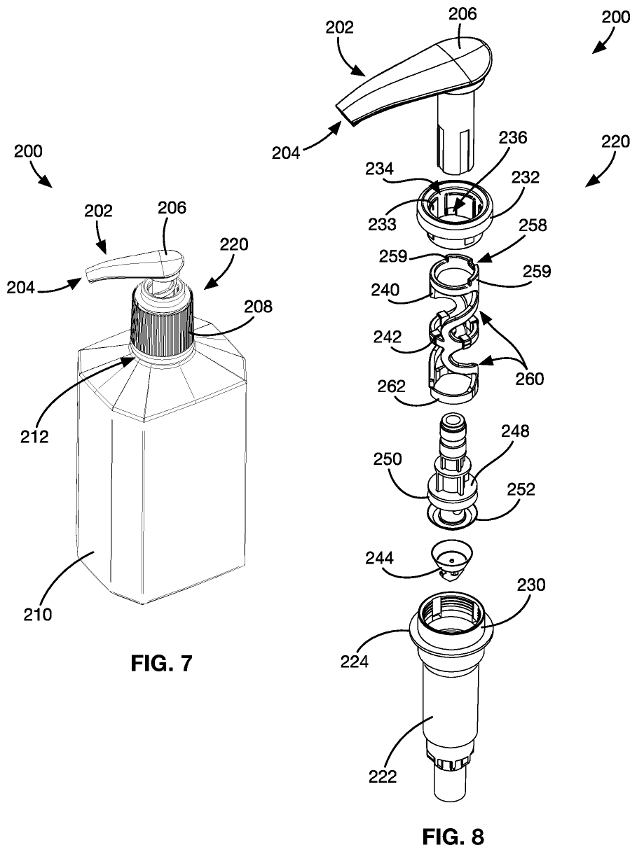

Referring now to FIGS. 7-15, illustrations of an exemplary dispenser 200 are shown. The dispenser 200 includes a nozzle 202 having a nozzle outlet 204. The nozzle 202 extends upward from a pump 220, forming a pump head 206. A fluid, such as, for example, hand sanitizer, is dispensed from the nozzle 202 when the pump head 206 is depressed by a user. The fluid is supplied to the nozzle 202 from a bottle 210 via a pump 220. The pump 220 is attached to the bottle 210 via a closure 208. The closure 208 attaches to a neck 212 of the bottle 210 after the bottle 210 is filled with fluid, such as, for example, hand sanitizer. The connection between the closure 208 and the neck 212 can take on a wide variety of forms, such as, for example, a threaded connection, a quarter-turn connection, a snap connection, a barbed connection, a press fit connection, an adhesive connection, a welded connection, or any other suitable repeatable or permanent connection.

The neck 212 of the bottle 210 has a smaller diameter than the rest of the bottle 210 and includes a mouth or opening 214 that facilitates filling the bottle 210 with fluid, such as, for example, hand sanitizer. The bottle 210 encloses a reservoir 216 for holding the fluid, e.g. hand sanitizer, and has a bottom 218. The bottom 218 of the bottle 210 is shaped to provide improved stability when the bottle 210 is placed on a tabletop or other approximately horizontal surface. For example, in some instances, stability can be increased via an indentation or concavity in the center of the bottom so that the surface area of the bottle that is in contact with the tabletop is arranged towards the outer perimeter of the bottle 210.

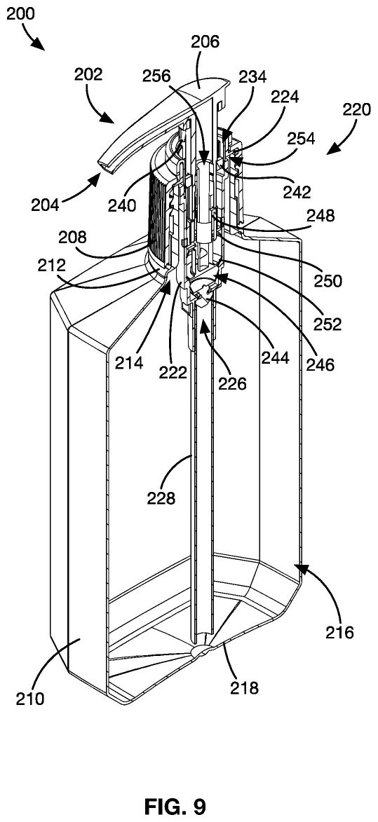

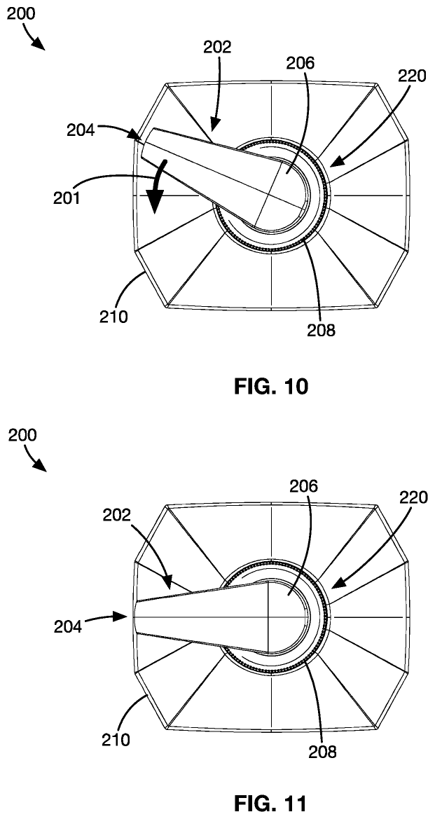

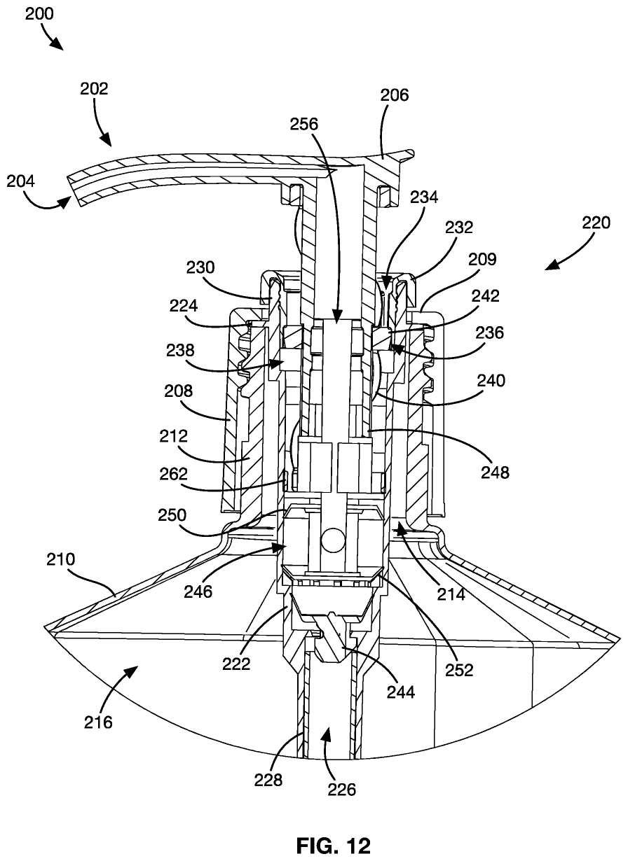

Referring now to FIGS. 9 and 12, cross-section views of the dispenser 200 and the pump 220 attached to the bottle 210 are shown. A pump housing 222, which has a cylindrical shape in this exemplary embodiment, encloses the pump 220. The pump housing 222 includes a flange 224 that engages the neck 212 of the bottle 210 when the pump 220 is inserted into the mouth or opening 214 of the bottle 210. The closure 208 secures the flange 224 against the neck 212 of the bottle 210 to form a seal between the pump 220 and the bottle 210 to prohibit leakage of hand sanitizer from the reservoir 216. An optional gasket or seal can be inserted between the mouth 214 of the bottle 210 and the flange 224 of the pump 220 to prohibit leakage from the reservoir 216.

The pump housing 222 extends into the bottle 210 to a pump inlet 226. An inlet tube 228 extends from the pump inlet 226 to near the bottom of the reservoir 216. Providing an inlet tube 228 that extends to the bottom of the reservoir 216 allows the dispenser 200 to dispense fluid from the reservoir 216 until the reservoir 216 is almost or completely empty, lengthening the time that the dispenser 200 can be used before it runs out and is disposed of or is refilled. Any suitable pump can be used to move fluid from the reservoir 216 to the nozzle outlet 204, such as, for example, a dome pump, a piston pump, a rotary pump, a gear pump, a sequentially activated multi-diaphragm pump, a liquid pump, a foam pump, or the like.

The pump housing 222 includes a cylindrical projection 230 that receives a collet or housing cap 232. A piston 222 extends upward through the pump housing cap or collet 232 attached to the upper end 230 of the pump housing 222.

The pump housing cap or collet 232 includes a locking portion 236 for engaging a corresponding engagement portion 242 of spring 240 for retaining the pump head 206 in a compressed or stowed position during shipment or storage of the dispenser 200 to prohibit unintentional actuation of the pump 220. Collet 232 also includes a plurality of recesses or slots 234 in the side wall 233. The recesses or slots 234 are configured so that engagement portion 242 can pass down through the collet 232 and into the locking portion 236.

The cap or collet 232 extends into the pump housing 222 to form an annular recess 238 between the housing cap or collet 232 and the pump housing 222. The housing cap or collet 232 can be threaded into a threaded opening of the pump housing 222 as shown, or can be attached in any other suitable way, such as, for example, via a quarter-turn connection, a snap connection, a barbed connection, a press fit connection, an adhesive connection, a welded connection, or any other suitable repeatable or permanent connection. The collet 232 and flange 224 of the pump housing 222 are on either side of a flange 209 of the closure 208 and secure closure 108 to the pump housing 222.

A pump spring 240 extends between the pump housing 222 and the pump head 206. During normal operation, the pump spring 240 biases the pump head 206 in an outward or upward direction to return the pump head 206 to the charged or primed position after actuation of the pump 220, as described below.

A top end 258 of the pump spring 240 engages the pump head 206 so that rotation of the pump head 206 also causes the pump spring 240 to rotate. The illustrated top end 258 has a pair of upward extending ridges 259 that engage with a pair of recesses (not shown) in pump head 206. The ridges 259 orientate the spring 240 with the pump head in addition to ensuring that rotation of the pump head also rotates spring 240.

Engagement tabs 242 of the pump spring 240 protrude radially outward from the pump spring 240 to engage slots 234 of the collet 232. The slots 234 extend vertically through the interior of the collet 232. Locking portions 236 extend horizontally from slots 234 along the bottom of collet 232. Slots 234, locking portion 236 and engagement tabs 242 are configured such that the engagement tabs 242 fit within the slots 234 and the locking portion 236.

Four engagement tabs 242, four slots 234 and four locking portion 236 are shown. There may be more or less than four of each of these parts. Generally, there are at least two of each of these parts.

The pump spring 240 includes an expandable lower end 262 for engaging the annular recess 238 when the spring 240 is moved from the stowed position to its normal operating position.

As can be seen in FIGS. 9 and 12, when the pump head 206 is in the stowed position, the pump spring 240 is stored inside of the housing 222, the engagement tabs 242 are disposed in the locking portions 236, and the expandable lower end 262 is compressed such that it fits within the pump housing 222. In the stowed or shipping condition, upward forces on the pump head 206 and piston 248 are resisted by the engagement tabs 242 that are captured in the locking portion 236.

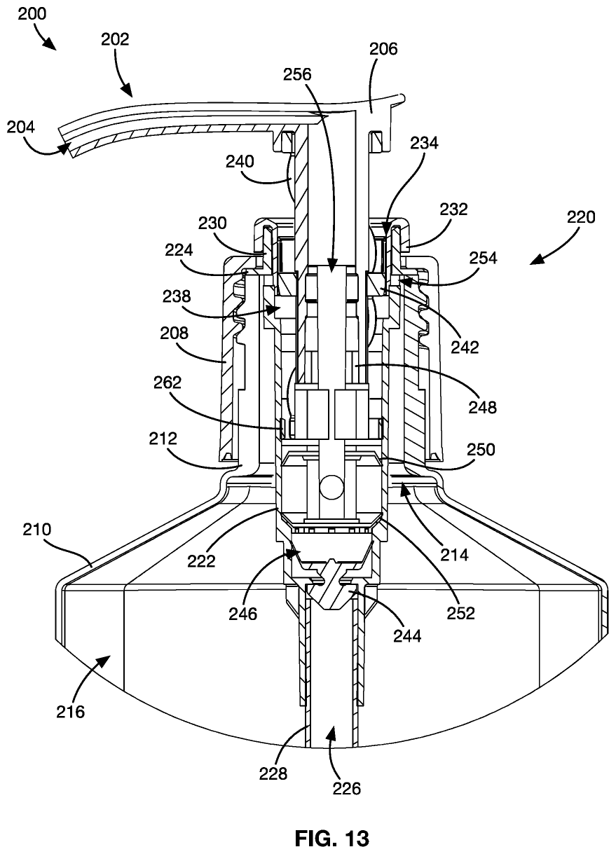

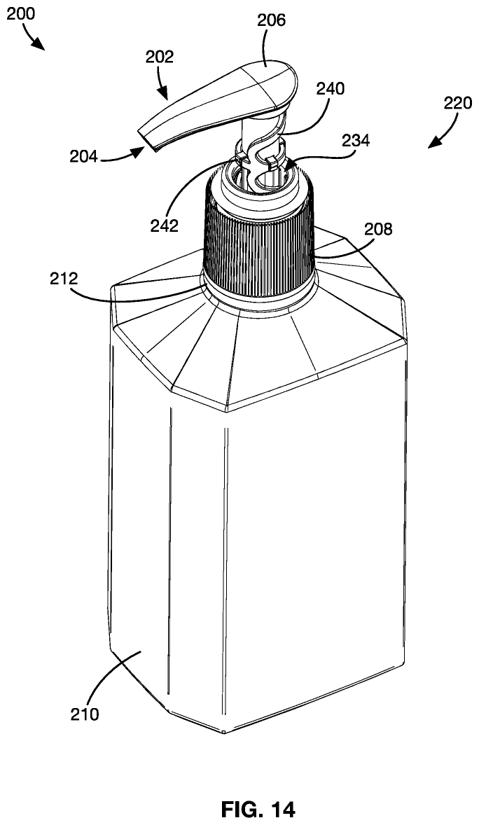

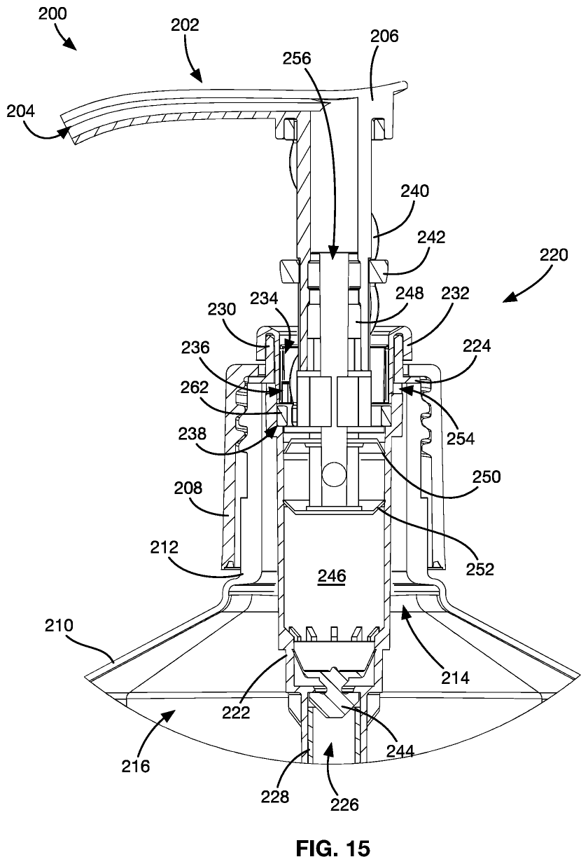

The pump head 206 can be pulled from the stowed position to the deployed position shown in FIGS. 14 and 15 after disengaging the engagement tabs 242 of the pump spring 240 from the locking portions 236. The engagement tabs 242 are moved out of the locking portions 236 by rotating the pump head 206 in an unlocking direction from a locked position (FIG. 10) to an unlocked position (FIG. 11). Because the pump head 206 is engaged with the top end 258 of the pump spring 240, rotation of the pump head 206 also rotates the pump spring 240 to move the engagement tabs 242 of the pump spring 240 out of the locking portions 236 and into the retaining slots 234, as can be seen in FIG. 13. The engagement tabs 242 are then free to move upward through the retaining slots 234 of the collet 232 as the pump head 206 is pulled vertically into the deployed position. When the pump head 206 reaches the deployed position, the expandable lower end 262 moves upward and expands to fit within the annular recess 238. The expandable lower end 262 becomes retained or secured in place in annular recess 238 and remains retained in the annular recess 238 throughout use of the dispenser 200.

As shown, spring 240 has an anchor means, which is the expandable lower end 242 as shown, and a retention means 238.

Additional anchor means include one or more of a flange, a conical member, one or more outward extending ridges. Additional anchor means may include one or more of a rough textured surface on both parts, or a tapered surface on both sides to provide a cork like fit between parts. In some instances, the taper is configured so that the more the spring is pulled on/lifted, the more it wants to bind with the inner surface of the top of part.

Additional retention means 238 include one or more of a flange, one or more ridges, a recesses, one or more inwardly extending ridges. Additional anchor means may include one or more of a rough textured surface on both parts, or a tapered surface on both sides to provide a cork like fit between parts. In some instances, the taper is configured so that the more the spring is pulled on/lifted, the more it wants to bind with the inner surface of the top of part.

In some embodiments, the anchor means is on the spring 240 and in some embodiments, the anchor means is on the pump housing 222. In some embodiments, the retention means is on the spring 240 and in some embodiments, the retention means is on the pump housing 222.

The anchor means and the retention means are configured such that when the anchor means and the retention means engage, the end of the spring 240 is retained in its operating position. When the dispenser 200 is in its stowed position, the anchor means and the retaining means are not engaged and the end of the spring 240 may be moved upward or outward from the pump 120.

The lower end 242 of spring 240 has a first position with respect to the pump housing 222 when the pump head 206 is in a stowed position for shipping and/or storage and a second position with respect to the pump housing 222 when in the operational position. When the lower end 242 of the spring 240 moves from the first position to the second position, the lower end 242 of the spring is fixed with respect to the second position.

As can be seen in FIG. 8, the pump spring 240 can be formed to include S-shaped flexible portions 260 arranged longitudinally along the length of the pump spring 240. When the pump spring 240 is compressed, the S-shaped flexible portions 260 are deformed vertically or longitudinally. Resistance to the deformation of each of the S-shaped flexible portions 260 is combined to provide the spring force of the pump spring 240 that biases the pump head 206 in an upward or expansion direction. In some implementations, the pump spring 240 includes oppositely arranged or mirrored S-shaped flexible portions 260 to limit twisting of the pump spring 240 during compression. Twisting movement during deformation of one S-shaped flexible portion 260 may be opposed out by an opposite twisting movement during deformation of an adjacent oppositely arranged or mirrored S-shaped flexible portion 260.

The pump spring 240 can be formed from injection molded plastic, or any other suitable material, such as, for example, vulcanized rubber, fiber glass, phenolic and wood fiber filled plastic. the plastic spring could also be made by casting or by extruding a tube, die cutting plastic from the tube to reveal the spring and then heat bending the end(s) to create a portion that will lock in. Forming the pump spring 240 from plastic reduces the cost of manufacturing the dispenser 200 and facilitates the creation of portions of the pump spring 240, such as, for example, the engagement tabs 242 and S-shaped flexible portions 260. Forming the pump spring 240 out of plastic allows the entire pump 220 to be readily recycled without necessitating breaking down the pump to remove a metal spring.

Pump springs 240 formed from plastic materials, however, can provide less spring force when the pump spring has been held in a compressed condition for a period of time, such as during storage and shipment of the dispenser. That is, storage in a compressed condition can cause a plastic spring to lose elasticity, resulting in a changed spring constant and reduced spring force. The dispenser 200 allows the pump spring 240 to remain in an expanded condition inside of the pump housing 220 when the pump head 206 is in the stowed position. Consequently, the dispenser 200 can include a pump spring 240 formed from a plastic material and can also be put into a stowed condition that has a reduced vertical height—and thus a reduced volume—for storage and shipping. In this way, the dispensers 200 described herein enable reduced manufacturing, shipping, and storage costs as well as saving costs and labor associated with breaking down the pump to remove metal parts so that the plastic pump can be recycled.

A one-way inlet valve 244 is fluidly connected to the pump inlet 226 and a pump chamber or accumulator 246. The inlet valve 244 is a pressure-actuated one-way valve that is oriented such that it allows fluid flow into the pump chamber 246 from the reservoir 216 when the vacuum pressure in the pump chamber 246 exceeds the cracking pressure of the one-way inlet valve 244 and the vacuum pressure required to draw liquid up from the reservoir 216. The inlet valve 244 can be any kind of one-way valve, such as a cross-cut valve, a wiper valve, a poppet valve, a flapper valve, an umbrella valve, a slit valve, a mushroom valve, a duck bill valve, or the like. Preferably the valve 244 is a plastic valve so that it may be recycled with the pump 220 without having to disassemble the pump 220 to remove the one-way valve 244.

The pump chamber 246 is formed by the pump housing 222, the inlet valve 244, and a piston 248. The piston 248 is hollow and includes a piston seal 250 and a pump outlet valve 252. The piston seal 250 forms a seal between the piston 248 and the pump housing 222.

A container vent hole 254 in the pump housing 222 provides a path from the outside atmosphere into the reservoir 216 to vent the reservoir 216 as liquid is pumped out of the reservoir. The pump outlet valve 252 is in fluid communication with the pump chamber 246 and a pump outlet 256. The pump outlet 256 is connected to the pump head 206 and nozzle 202 to provide a fluid path from the pump chamber 246 to the nozzle outlet 204.

The pump outlet valve 252 is a one-way valve that is fluidly connected to the pump chamber 246 and the pump outlet 256. The one-way outlet valve 252, like the pump inlet valve 244, is a one-way valve that is oriented such that it allows flow out of the pump chamber 246 and into the pump outlet 256 when the pressure of the liquid inside the pump chamber 246 exceeds the pressure in the pump outlet 256. The outlet valve 252 can be any kind of one-way valve, such as a cross-cut valve, a wiper valve, a poppet valve, a flapper valve, an umbrella valve, a slit valve, a mushroom valve, a duck bill valve, or the like. Preferably the outlet valve 252 is made of plastic so that it does not need to be removed from the pump 220 prior to recycling the pump 220.

Once the pump spring 240 has been moved upward so that the expandable portion 262 is retained in slot 238, during operation, the user presses down on the pump head 206 to move the piston 248 downward to compress the pump chamber 246 to the compressed position. During compression of the pump chamber 246, the fluid pressure increases so that the inlet valve 244 closes and the outlet valve 252 opens, thereby allowing the contents of the pump chamber 246 to flow out of the outlet valve 252, through the nozzle 202 and nozzle outlet 204, and into the hand of the user. When force on the pump head 206 is released, the pump spring 240 pushes the piston 248 upward to expand the pump chamber 246. During expansion of the pump chamber 246, the pressure in the pump chamber 246 reduces. The inlet valve 244 opens and the outlet valve 252 closes and the pump chamber 246 with fluid from the reservoir 216 to charge the pump 220 for the next time a user wants to dispense hand sanitizer.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

What is claimed is:

1-2. (canceled)

3. A tabletop dispenser comprising:
a container;
the container having a neck;
a pump;
a pump housing;
the pump housing having an upper end and a lower end;
a nonmetallic pump spring;
the nonmetallic pump spring having a lower end;
wherein the lower end of the nonmetallic pump spring is located in a first position prior to an initial operation of the pump and a second position during normal operation of the pump;
wherein the lower end of the nonmetallic pump spring moves upward from the first position to the second position;
wherein when the lower end of the nonmetallic pump spring is in the first position, the nonmetallic pump spring is not compressed.

4. The tabletop dispenser of claim 3 wherein the pump spring is a wave spring.

5. The tabletop dispenser of claim 3 wherein the pump spring comprises one or more S portions.

6. (canceled)

7. The tabletop dispenser of claim 3 comprising a collet that comprises a retention member for securing the nozzle in a stowed position.

8-11. (canceled)

12. The tabletop dispenser of claim 3 wherein the pump housing has an annular recess and the nonmetallic pump spring has an expandable lower end and wherein when the pump is shipped or stored, the expandable lower end is below the annular recess; wherein the expandable lower end is compressed within the pump housing;
wherein the expandable lower end is configured to be moved upward so that the expandable lower end expands in the annular recess to secure the expandable lower end to the pump housing.

13. The tabletop dispenser of claim 12 wherein the lower end of the nonmetallic pump spring is located lower down in the pump housing when the pump is in a stowed position and higher up in the pump housing when the pump is in an operating position.

14. The tabletop dispenser of claim 3 wherein the non-metallic pump spring is uncompressed when the nozzle is in a stowed position.

15. The tabletop dispenser of claim 3 wherein the non-metallic pump spring is under less compression when the nozzle is in a stowed position then the non-metallic pump spring is when the nozzle is in an operating position.

16. The tabletop dispenser of claim 3 further comprising a nonmetallic liquid inlet valve.

17. The tabletop dispenser of claim 3 further comprising a nonmetallic liquid outlet valve.

18. The tabletop dispenser of claim 3 further comprising a nonmetallic pump housing.

19. The tabletop dispenser of claim 3 wherein the non-metallic pump spring rotates when the nozzle rotates, and wherein the nozzle rotates between a locked stowed position and an unlocked operating position.

20. (canceled)

21. A tabletop dispenser comprising:
a container comprising a neck;
a pump comprising:
a pump housing;
a pump spring;
a collet attached to an upper end of the pump housing; and
a pump head extending through the collet;
wherein the pump head is movable between a stowed and a deployed position; and
wherein the pump spring is in an uncompressed condition when the pump head is in the stowed position; and
a closure for securing the pump to the neck of the container.

22-23. (canceled)

24. The tabletop dispenser of claim 21, wherein the pump spring comprises two S-shaped flexible portions that are oppositely arranged.

25. The tabletop dispenser of claim 21, wherein the collet comprises a retaining portion for engaging a corresponding engaging portion of the pump head.

26. The tabletop dispenser of claim 21, wherein the collet comprises a retaining slot for engaging a corresponding engaging tab of the pump spring.

27. (canceled)

28. The tabletop dispenser of claim 26, wherein rotating the pump spring disengages the engaging tab of the pump spring from a locking portion.

29-34.

35. A tabletop dispenser comprising:
a container comprising a neck;
a pump comprising:
a pump housing;
a pump spring;
a collet attached to an upper end of the pump housing; and
a pump head extending through the collet;
wherein the pump head is movable between a stowed and a deployed position; and
wherein the pump spring is in an uncompressed condition when the pump head is in the stowed position; and
a closure for securing the pump to the neck of the container.

36. The tabletop dispenser of claim 35, wherein the pump spring is formed from a plastic material.

37-46. (canceled)

47. The tabletop dispenser of claim 36, wherein:
an annular groove is formed between the collet and the pump housing; and
the pump spring comprises an expandable lower end for engaging the annular groove when the pump head is in the deployed position.

48-49. (canceled)
